(19) United States
(12) Patent Application Publication
(10) Pub. No.: US 2015/0246419 A1
(43) Pub. Date: Sep. 3, 2015

(54) SYSTEM AND METHOD OF INSTALLING A LINER IN A PROPSHAFT FOR A VEHICLE

(71) Applicant: GM GLOBAL TECHNOLOGY OPERATIONS LLC, Detroit, MI (US)

(72) Inventor: Steven W. Creek, Shelby Township, MI (US)

(73) Assignee: GM GLOBAL TECHNOLOGY OPERATIONS LLC, Detroit, MI (US)

(21) Appl. No.: 14/193,599

(22) Filed: Feb. 28, 2014

(51) Int. Cl. B23P 19/04

(52) U.S. Cl. CPC B23P 19/04

(57) ABSTRACT

A propshaft includes a tube and a liner. The tube extends along an axis to an end. The tube defines a cavity having a first inner diameter and the end defines an inlet opening having a second inner diameter, less than the first inner diameter. The liner has an outer diameter that is greater than the second inner diameter of the tube. An insertion device is applied to the liner. The insertion device is moved, relative to the tube, such that the liner is caused to axially move along the axis and the outer diameter of the liner is caused to radially compress so as to move through the inlet opening and into the cavity of the tube.

### TECHNICAL FIELD

The present disclosure is related to a system and method of installing a liner in a propshaft for a vehicle.

### BACKGROUND

A propshaft is part of a vehicle's driveline. The propshaft is configured to carry torque and power from a prime mover or transmission to an output device, such as a differential assembly of an axle or a transfer case. The propshaft rotates to transmit the drive force generated by the engine to one or more wheels, typically via the differential assembly or the transfer case. Liners or dampers may be used inside the propshaft to suppress driveline noise.

### SUMMARY

One possible aspect of the disclosure provides a method of assembling a propshaft. The method includes providing a tube extending along an axis to an end. The tube defines a cavity having a first inner diameter and the end defines an inlet opening having a second inner diameter, less than the first inner diameter. A liner is also provided. The liner has an outer diameter that is greater than the second inner diameter of the tube. An insertion device is applied to the liner. The insertion device is moved such that the liner is caused to axially move along the axis and the outer diameter of the liner is caused to radially compress so as to move through the inlet opening and into the cavity of the tube.

In another aspect of the disclosure, an insertion tool is provided for inserting a liner into a cavity within a propshaft for a vehicle. The insertion tool includes a funnel device and a drive device. The funnel device extends along an axis and defines a passage tapering in diameter from a first insert diameter to a second insert diameter. The drive device is configured for movement along the passage of the funnel device to apply an axial force to the liner to thereby insert the liner into a cavity of the propshaft.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic illustrative view of a vehicle having a driveline including a propshaft.

FIG. 2 is a schematic fragmentary cross-sectional side view of the propshaft including liners disposed in a cavity.

FIG. 3 is a schematic fragmentary partial cross-sectional side view of the propshaft and an insertion tool with the liner disposed in a funnel of the insertion tool.

FIG. 4 is a schematic fragmentary partial cross-sectional side view of the propshaft and the insertion tool of FIG. 3 with the liner disposed in the cavity of the propshaft.

FIG. 5 is a schematic fragmentary partial cross-sectional side view of the propshaft and another embodiment of the insertion tool with the liner outside of the cavity of the propshaft.

FIG. 6 is a schematic fragmentary partial cross-sectional side view of the propshaft with the insertion tool engaging the insert while axially and radially inserting the liner into the cavity of the propshaft.

FIG. 7 is a schematic fragmentary partial cross-sectional side view of the propshaft with the liner disposed in the cavity of the propshaft and the insertion tool axially disengaging the liner.

FIG. 8 is a schematic fragmentary partial cross-sectional side view of the propshaft illustrating a combination of the funnel device and the drive device.

### DETAILED DESCRIPTION

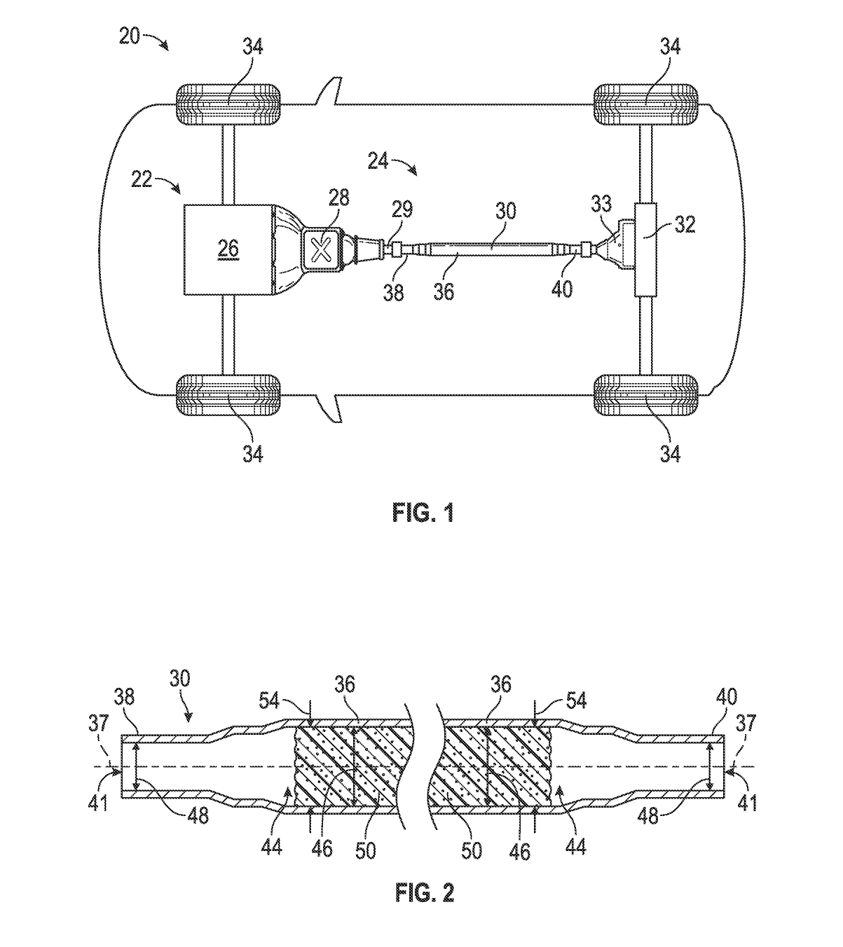

Referring to the drawings, wherein like reference numbers refer to like components throughout the several Figures, a vehicle 20 having a powertrain 22 and a driveline 24 is shown schematically in FIG. 1.

While the present invention may be described with respect to automotive or vehicular applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims. Any numerical designations, such as “first” or “second” are illustrative only and are not intended to limit the scope of the invention in any way.

Features shown in one figure may be combined with, substituted for, or modified by, features shown in any of the figures. Unless stated otherwise, no features, elements, or limitations are mutually exclusive of any other features, elements, or limitations. Any specific configurations shown in the figures are illustrative only and the specific configurations shown are not limiting of the claims or the description.

The powertrain 22 may include an engine 26 and a transmission 28. The transmission 28 includes an output member 29 extending from the transmission 28. The driveline 24 includes a propshaft 30 (i.e., a propeller shaft or driveshaft), a rear axle 32, and a plurality of wheels 34. The propshaft 30 may be operatively connected to the output member 29 at one end and to the rear axle 32 (via a rear differential 33) at another end in order to transmit drive force or torque generated by the engine 26 to the rear axle 32. Alternatively, the vehicle 20 may include a transfer case (not shown) operatively connected to the propshaft 30.

Referring now to FIG. 2, the propshaft 30 includes a tube 36, extending along a first axis 37 between a first end 38 and a second end 40, opposing the first end 38. The tube 36 is cylindrical and defines a cavity 44 having a first inner diameter 46. The ends 38, 40 each define an inlet opening 41 that opens to the cavity 44. The tube 36 may be swaged, which results in the inlet opening 41 at the first end 38 and the second end 40 to each have a second inner diameter 48 that is less than the first inner diameter 46. The reduced inner diameters 48 of each end 38, 40 may be provided for a variety of reasons, such as to allow smaller, less costly weld yokes to be attached to the tube 36, improved tool installation during assembly of the propshaft 30 to the vehicle 20, and the like.

At least one liner 50 is operatively disposed within the tube 36 of the propshaft 30. The liner 50 is provided to suppress driveline noise created during operation of the vehicle 20. More specifically, during operation of the vehicle 20, the propshaft 30 rotates about the first axis 37 to transmit torque to the rear axle 32. As the propshaft 30 rotates about the first axis 37, tube 36 has the tendency to vibrate or resonate. The liners 50 are disposed within the tube 36 at locations that generally correspond to the antinodes (i.e., bending modes) of the propshaft 30. It should also be appreciated that a separate liner 50 may be inserted into each end 38, 40 of the driveshaft 30. The insertion of the liners 50 into each end 38, 40 may occur simultaneously. Alternatively, the liners 50 may be installed into each end 38, 40 at different times.

The liner 50 may be formed from a compressible material. The compressible material may include a foam material, such as polyester foam, polyurethane foam, polystyrene foam, and other similar materials or combinations thereof. In one non-limiting example, the foam material is polyester foam having a density ranging from 0.5-2.5 pounds per cubic foot (pcf). More preferably, the density of the foam material ranges from 1.0-1.4 pd. Even more preferably, the density of the foam material is 1.2 pd.

The liner 50 is generally tubular in shape and extends along a first length 52. When the liner 50 is uncompressed, i.e., is not inserted into the cavity 44 of the tube 36, the liner 50 has an outer diameter 54 that is greater than the first inner diameter 46 and the second inner diameter 48. However, once the liner 50 is inserted into the cavity 44 of the tube 36, the liner 50 may be radially compressed by the tube 36 such that the outer diameter 54 of the liner 50 is equal to the first inner diameter 46 of the tube 36, resulting in an interference fit between the tube 36 and the liner 50.

In order to achieve the reduced diameter at each end 38, 40, the ends 38, 40 are swaged or otherwise undergo some form of heat treatment process. However, the compressible material of the liner 50 is not capable of withstanding the elevated temperatures achieved during the heat treat processing, without melting or otherwise becoming deformed. Therefore, the liners 50 must be inserted into the cavity 44 after the ends 38, 40 are heat treated. Further, since the second inner diameter 48 at each end 38, 40 is less than the outer diameter 54 of the liner 50, the liner 50 must be radially compressed to fit through the respective inlet opening 41, as the liner 50 is axially inserted into the cavity 44.

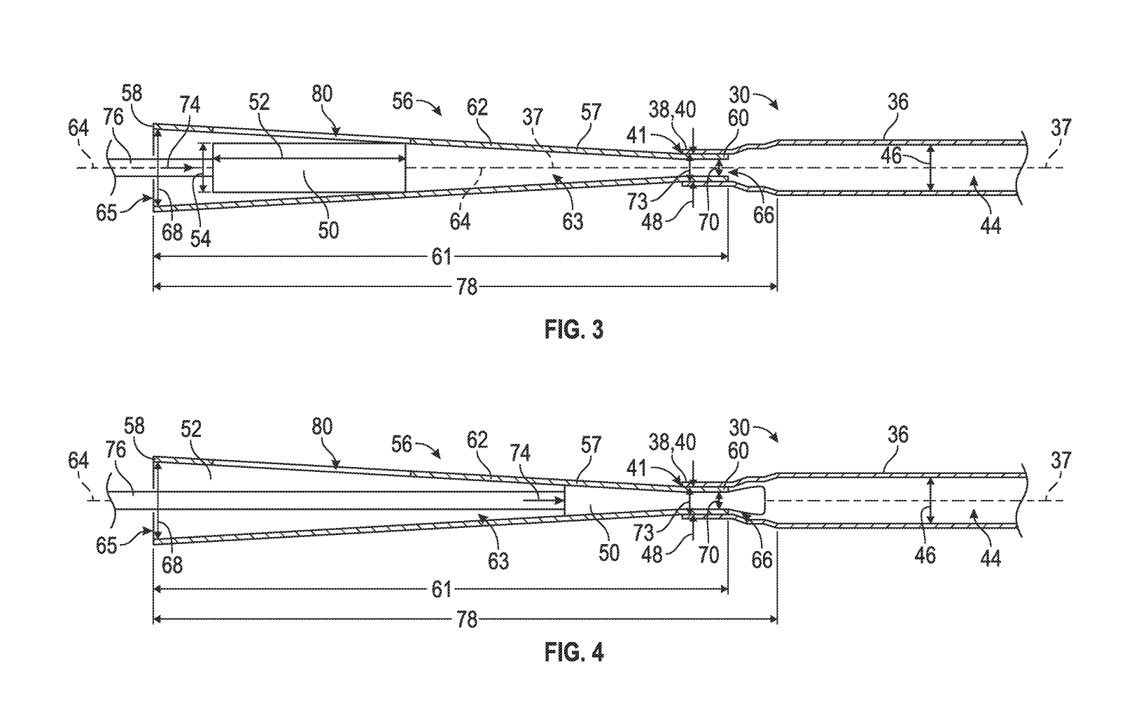

Referring now to FIG. 3, an insertion tool 56 may be provided to facilitate the radial compression of the liner 50 as the liner 50 is axially inserted into the cavity 44 of the tube 36. The insertion tool 56 includes a funnel device 57 that extends a second length 61 along a second axis 64 between a first insert end 58 and a second insert end 60. The funnel device 57 includes a body 62 disposed between the ends 58, 60. The body 62 surrounds the second axis 64 and has a generally frustoconical shape (i.e., the shape of a truncated cone). The body 62 defines a passage 63 that is also generally frustoconical in shape. The first insert end 58 defines a first insert opening 65 and the second insert end 60 defines a second insert opening 66. Each insert opening 65, 66 is open to the passage 63. The first insert opening 65 has a first insert diameter 68 and the second opening 66 has a second insert diameter 70. Since the passage 63 is frustoconical in shape, the size of the inner diameter of the passage 63 decreases or otherwise tapers from the first insert diameter 68 to the second insert diameter 70 such that the second insert diameter 70 is smaller than the first insert diameter 68. The passage 63 is configured to receive the liner 50 at, or proximate, the first insert end 58. Therefore, in order to receive the liner 50 in a radially uncompressed state, the first insert diameter 68 is sized to be at least equal to the outer diameter 54 of the insert 50. Likewise, since the funnel device 57 is configured to sequentially radially compress the liner 50 as the liner 50 is axially inserted through the inlet opening 41 and into the cavity 44 of the propshaft 30, the second insert diameter 70 is less than the outer diameter 54 of the liner 50. Therefore, the second insert diameter 70 is not greater than the second inner diameter 48 of the tube 36.

With continued reference to FIG. 3, in operation, the second insert end 60 may be inserted into the inlet opening 41 of the propshaft 30 such that the second axis 64 of the insert device is aligned with the first axis 37 of the tube 36. Therefore, it should be appreciated that in order for the second insert end 60 to fit within the inlet opening 41, the second insert end 58 has an insert outer diameter 73 that is not greater than the second inner diameter 48 and the second insert diameter 70 is less than the second inner diameter 48.

The liner 50 is received within the passage 63 of the insertion tool 56 at, or proximate, the first insert end 58. An axial force 74 is axially applied to the liner 50, in a direction toward the propshaft 30. In response to the application of the axial force 74 to the liner 50, the liner 50 moves axially along the passage 63 of the funnel device 57, toward the cavity 44 of the propshaft 30. The axial force 74 may be applied by a ram 76 via a press machine. Since the inner diameter of the passage 63 tapers from the first insert end 58 to the second insert end 60, and the second insert diameter 70 is less than the outer diameter 54 of the liner 50, the liner 50 is gradually radially compressed, i.e., sequentially radially compressed, by the body 62, as the liner axially moves within the passage 63, toward the second insert end 60, as illustrated in FIG. 4. The ram 76 is of sufficient length to plunge through the passage 63 a distance 78 that seats the liner 50 completely within the cavity 44 of the tube 36. More specifically, the distance 78 may be at least equal to the second length 61 of the funnel device 57. Once the liner 50 is seated within the cavity 44, the ram 76 is axially retracted from the cavity 44 of the tube 36 and the passage 63 of the funnel device 57. Further, as the liner 50 enters the cavity 44, via the inlet opening 41, the outer diameter 54 sequentially radially expands until the liner 50 is seated within the cavity 44 via an interference fit.

Referring again to FIG. 3, the body 62 of the funnel device 57 may define a notch 80, proximate the first insert end 58. The notch 80 opens to the passage 63 and is of sufficient size to receive the liner 50. Therefore, the notch 80 may be provided to allow the liner 50 to be loaded as a cartridge, in combination with using the ram 76 to subsequently axially apply the axial force 74.

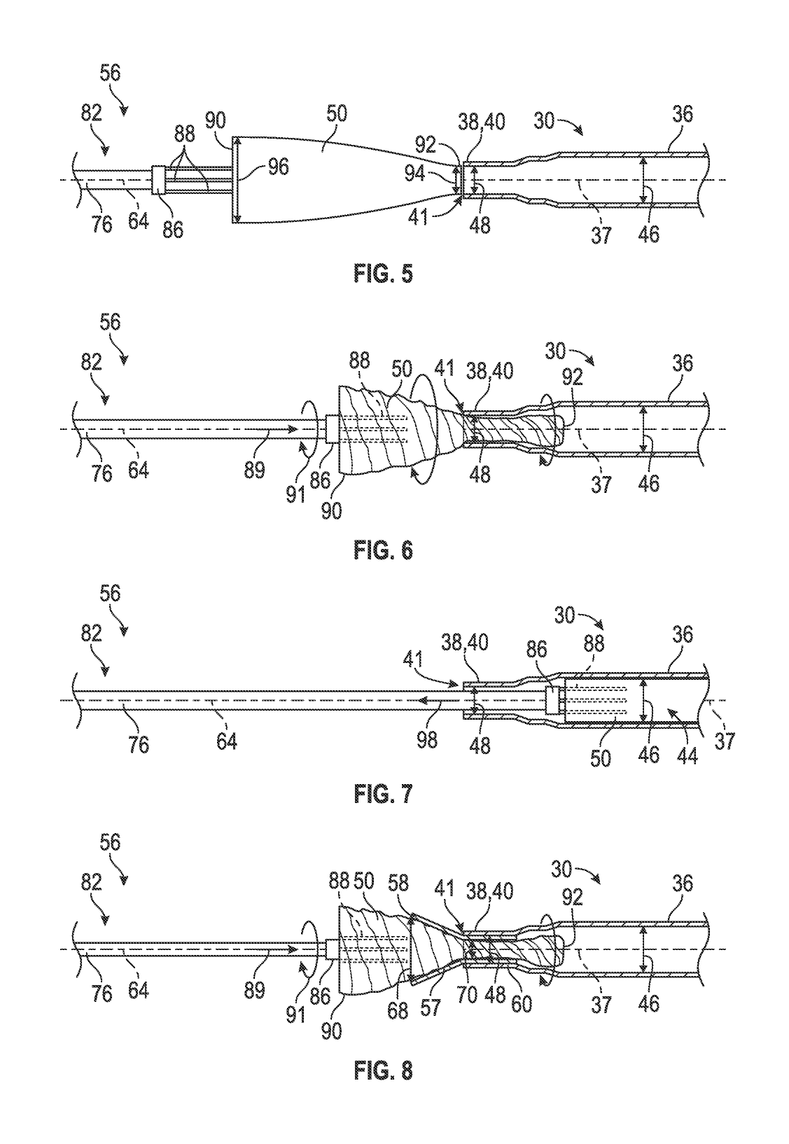

Referring now to FIGS. 5-7, another embodiment of the insertion tool 56 is shown. The insertion tool 56 includes a drive device 82 configured to facilitate the radial compression of the liner 50 as the liner 50 is axially inserted into the cavity 44 of the tube 36 along the first axis 37. The drive device 82 includes a ram 76, a socket 86, and a plurality of fingers 88. The socket 86 is operatively attached to the ram 76 and the fingers 88 are operatively attached to the socket 86 such that the ram 76, the socket 86, and the fingers 88 extend along a second axis 64. The drive device 82 is configured to move axially along the second axis 64, in an axial direction (arrow 89), while simultaneously rotating about the second axis 64 (arrow 91).

The fingers 88 of the drive device 82 are configured to pierce a proximal end 90 of the liner 50 such that the fingers 88 are axially embedded in the liner 50. Piercing the proximal end 90 of the liner 50 allows the drive device 82 to rotate the liner 50 about the second axis 64, relative to the propshaft 30, as indicated by arrow 91.

With reference to FIG. 5, in order to facilitate insertion of the liner 50 within the cavity 44 of the tube 36, a distal end 92 of the liner 50, opposite the proximal end 90, may be formed to have a distal diameter 94 that is less than a proximal diameter 96 at the proximal end 90. More specifically, the liner 50 may be configured such that the outer diameter of the liner 50 tapers near the distal end 92. The distal diameter 94 may be sized to be equal to or less than the second inner diameter 48 of the tube 36 of the propshaft 30. The proximal diameter 96 may be sized to be at least equal to the first inner diameter 46 of the tube 36 to ultimately allow for an interference fit between the liner 50 and the tube 36, as already described above.

Once the fingers 88 are embedded within the proximal end 90 of the liner 50, and with the second axis 64 of the drive device 82 in alignment with the first axis 37 of the tube 36, the drive device 82 is rotated about the second axis 64, as indicated by arrow 91, while also moving axially along the second axis 64, as indicated by arrow 89. The drive device 82 is continuously rotated and moved axially as the distal end 92 of the liner 50 is inserted into the inlet opening 41 of the tube 36. As the liner 50 is moved axially along the second axis 64, the tube 36 engages the liner 50, at or proximate the distal end 92, resulting in the liner 50 at the proximal end 90 rotating about the second axis 64, relative to the distal end 92. As such, the liner 50 is twisted, i.e., wrung, about the second axis 64, while also being moved along the second axis 64. Twisting of the liner 50 causes the outer diameter of the liner to be reduced. As the twisting and axial movement of the liner continues, the liner 50 is screwed into the cavity 44 of the tube 36 of the propshaft.

The ram 76 of the drive device 82, in combination with the socket, is of sufficient length to seat the liner 50 completely within the cavity 44 of the tube 36. Once the liner 50 is seated within the cavity 44, the drive device 82 is axially refracted from the cavity 44 of the tube 36 (see arrow 98).

Referring now to FIG. 8, in another embodiment, the insertion tool 56 may be configured as a combination of the funnel device 57, illustrated in FIGS. 3 and 4, and the drive device 82, illustrated in FIGS. 5-7. In this combination, the funnel device 57 is inserted into the inlet opening 41 and the drive device 82 is used in lieu of the ram 76. As such, the drive drive 82 moves the liner 50 axially along the second axis 64, while the liner is engaged by the funnel device 57 to twist the liner 50. A combination of the twisting of the liner 50 and the tapering of the insert diameter of the funnel device 57 allow the liner 50 to be screwed into the cavity 44 of the tube 36 of the propshaft 30.

While the best modes for carrying out the many aspects of the present teachings have been described in detail, those familiar with the art to which these teachings relate will recognize various alternative aspects for practicing the present teachings that are within the scope of the appended claims.

1. A method of assembling a propshaft, the method comprising:
providing a tube extending along an axis to an end, wherein the tube defines a cavity having a first inner diameter and the end defines an inlet opening having a second inner diameter, less than the first inner diameter;
providing a liner having an outer diameter that is greater than the second inner diameter of the tube; and
applying an insertion device to the liner; and
moving the insertion device such that the liner is caused to axially move along the axis and the outer diameter of the liner is caused to radially compress so as to move through the inlet opening and into the cavity of the tube.

2. A method, as set forth in claim 1, wherein moving the insertion device is further defined as moving the insertion device such that the liner is caused to axially move along the axis and the outer diameter of the liner is caused to radially compress so as to move through the inlet opening and into the cavity of the tube and the outer diameter is caused to sequentially radially expand within the chamber.

3. A method, as set forth in claim 1, wherein providing a liner is further defined as providing a liner having an outer diameter that is greater than each of the first and second inner diameter of the tube; and
wherein the liner is configured to form an interference with the tube when the liner is caused to sequentially radially expand within the chamber.

4. A method, as set forth in claim 1, wherein applying an insertion device is further defined as:
inserting a funnel device into the inlet opening, wherein the funnel device defines a passage tapering in diameter from a first insert diameter to a second insert diameter;
inserting the liner into the passage of the funnel device; and
applying an axial force to the liner such that the liner is caused to axially move along the passage of the funnel device and the tapered diameter causes the liner to sequentially radially compress before the liner is moved through the inlet opening and into the cavity of the tube.

5. A method, as set forth in claim 1, wherein applying an insertion device further includes:
inserting a plurality of fingers of a drive device into a proximal end of the the liner;
wherein applying an axial force is subsequent to inserting the plurality of fingers into the liner.

6. A method, as set forth in claim 5, wherein applying an insertion device further includes:
rotating the drive device about the axis such that the proximal end of the liner twists about the axis, relative to a distal end, to cause the outer diameter of the liner to radially compress.

7. A method, as set forth in claim 6, wherein applying an axial force and rotating the drive device about the axis are simultaneous.

8. A method, as set forth in claim 6, wherein rotating the drive device about the axis further includes rotating the drive device about the axis such that the liner is screwed into the cavity of the tube.

9. A method, as set forth in claim 1, wherein applying an insertion device is further defined as:
inserting a plurality of fingers of a drive device into a proximal end of the liner;
rotating the drive device about the axis such that the proximal end of the liner twists about the axis, relative to a distal end, to cause the outer diameter of the liner to radially compress and the distal end of the liner rotates about the axis, relative to the end of the tube, to cause the liner to screw into the cavity of the tube.

10. A method, as set forth in claim 9, wherein rotating the drive device about the axis such that the proximal end of the liner twist about the axis, relative to a distal end

11. An insertion tool for inserting a liner into a cavity within a propshaft for a vehicle, the insertion tool comprising:
a funnel device extending along an axis and defining a passage tapering in diameter from a first insert diameter to a second insert diameter; and
a drive device configured for movement along the passage of the funnel device to apply an axial force to the liner to thereby insert the liner into the cavity of the propshaft.

12. An insertion tool, as set forth in claim 11, wherein the funnel device includes a body disposed between a first insert end and a second insert end;
wherein the body surrounds the axis to define the passage; and
wherein the passage is generally frustoconical in shape.

13. An insertion tool, as set forth in claim 12, wherein the first insert end defines a first insert opening and the second insert end defines a second insert opening;
wherein each of the first and second insert openings is open to the passage.

14. An insertion tool, as set forth in claim 13, wherein the first insert opening has a first insert diameter and the second insert opening has a second insert diameter, less than the first insert diameter.

15. An insertion tool, as set forth in claim 14, wherein the body defines a notch, proximate the first insert end;
wherein the notch extends in spaced relationship to the axis and opens to the passage; and
wherein the notch is sized to receive the liner therethrough to insert the liner into the passage.

16. An insertion tool, as set forth in claim 11, wherein the drive device includes:
a ram;
a plurality of fingers extending from the ram;
wherein the plurality of fingers are configured to engaging a proximal end of the liner; and
wherein the drive device is configured for movement along the passage of the funnel device to apply an axial force to the liner to thereby insert the liner into a cavity of the propshaft.

17. An insertion tool, as set forth in claim 16, wherein the insertion tool is configured for rotation about the axis such that the proximal end of the liner twists about the axis, relative to a distal end of the liner, to cause an outer diameter of the liner to radially compress.
